(19) United States
(12) Patent Application Publication
(10) Pub. No.: US 2025/0058646 A1
(43) Pub. Date: Feb. 20, 2025

(54) BATTERY ELECTRIC VEHICLE

(71) Applicant: TOYOTA JIDOSHA KABUSHIKI KAISHA, Toyota-shi (JP)

(72) Inventors: Yoichiro ISAMI, Toyota-shi (JP); Kenji MIZUTANI, Toyota-shi (JP); Hirotaka IKEGAMI, Toyota-shi (JP); Akihito YASUE, Toyota-shi (JP)

(73) Assignee: TOYOTA JIDOSHA KABUSHIKI KAISHA, Toyota-shi (JP)

(21) Appl. No.: 18/804,976

(22) Filed: Aug. 14, 2024

(30) Foreign Application Priority Data
Aug. 17, 2023 (JP) 2023-132952

(51) Int. Cl. B60L 15/20

(52) U.S. Cl. CPC B60L 15/20; B60L 2240/423; B60L 2250/16; B60L 2260/20

(57) ABSTRACT

The present disclosure provides a battery electric vehicle enables the driver to recognize whether the vehicle is driven in a motor driving mode or in a variable speed driving mode. The controller is programmed to control the display apparatus to display simulated rotation speed as rotation speed of the engine in the engine vehicle with simulated torque behavior when the variable speed driving mode is selected by the mode selector, and not to display the simulated rotation speed when the motor driving mode is selected by the mode selector. This enables the driver to recognize whether the vehicle is driven in the motor driving mode or in the variable speed driving mode.

### CROSS-REFERENCE TO RELATED APPLICATION

The present disclosure claims priority to Japanese Patent Application No. 2023-132952 filed on Aug. 17, 2023, which is incorporated herein by reference in its entirety including specification, drawings and claims.

### TECHNICAL FIELD

The present disclosure relates to a battery electric vehicle.

### BACKGROUND

A proposed battery electric vehicle includes a motor outputting power to a drive shaft connected to an axle, and a mode selector selecting one driving mode from multiple driving modes, including a motor driving mode and a variable speed driving mode, by an operation of driver (as described in, for example, Japanese Laid-Open Patent Publication No. 2022-036845). The motor driving mode is for driving while controlling the motor such that required torque required for driving is output to the drive shaft. The variable speed driving mode is for driving while controlling the motor such that a torque output to the drive shaft based on driver's shift operation becomes a torque simulating torque behavior in an engine vehicle equipped with an engine and a stepped transmission.

### SUMMARY

In the battery electric vehicle described above, it may be difficult for the driver to recognize whether the vehicle is driven in the motor driving mode or the variable speed driving mode.

A battery electric vehicle of the present disclosure mainly aims to allow the driver to recognize whether the vehicle is driven in the motor driving mode or the variable speed driving mode.

In order to achieve the above primary object, the battery electric vehicle of the present disclosure employs the following configuration.

The present disclosure is directed to a battery electric vehicle. The battery electric vehicle includes a motor configured to output torque to a drive shaft connected to an axle, a mode selector configured to select one driving mode from a plurality of driving modes, including a motor driving mode for driving while controlling the motor such that required torque required for driving is output to the drive shaft, and a variable speed driving mode for driving while controlling the motor based on driver's shift operation such that a torque output to the drive shaft becomes a torque simulating torque behavior in an engine vehicle equipped with an engine and a stepped transmission, by an operation of the driver, a display apparatus configured to display information, and a controller programmed to control the motor to be driven in the driving mode selected by the mode selector, and to control the display apparatus. The controller is programmed to control the display apparatus to display simulated rotation speed as rotation speed of the engine in the engine vehicle with simulated torque behavior when the variable speed driving mode is selected by the mode selector, and not to display the simulated rotation speed when the motor driving mode is selected by the mode selector.

### BRIEF DESCRIPTION OF DRAWINGS

FIG. 1 is a configuration diagram illustrating the schematic configuration of a battery electric vehicle 20 according to one embodiment of the present disclosure.

FIG. 2 illustrates one example of display on a display 42 in a motor driving mode.

FIG. 3 illustrates one example of display on the display 42 in a variable speed driving mode.

### DESCRIPTION OF EMBODIMENTS

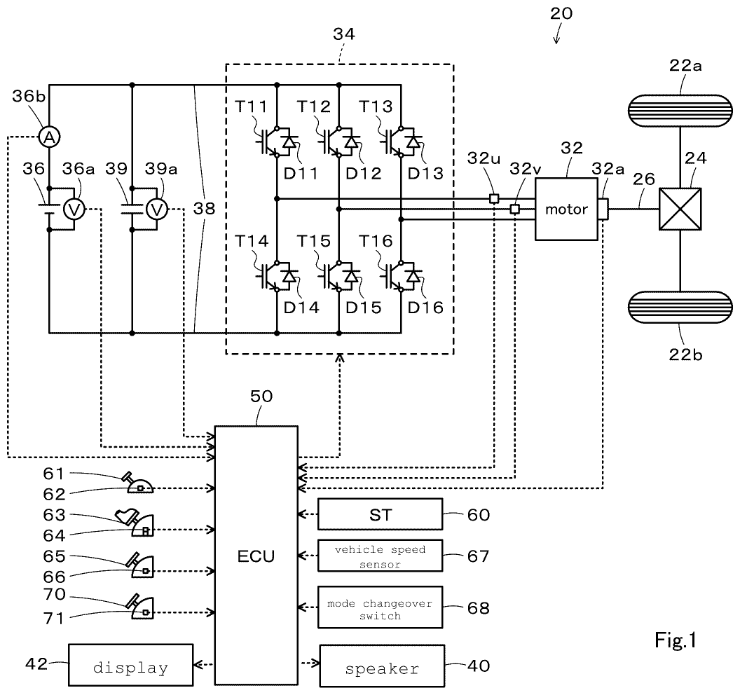

The following describes some aspects of the disclosure with reference to embodiments. FIG. 1 is a configuration diagram illustrating the schematic configuration of a battery electric vehicle 20 according to one embodiment of the present disclosure. The battery electric vehicle 20 includes a motor 32 for driving, an inverter 34, a battery 36, a speaker 40, a display (a display apparatus) 42, and an electronic control unit (a controller, hereinafter referred to as “ECU”) 50, as shown.

The motor 32 is configured as a three-phase AC motor and includes a rotor with permanent magnets embedded in a rotor core and a stator with three-phase coils wound around a stator core. The rotor of the motor 32 is connected to a drive shaft 26 connected to drive wheels 22a and 22b via a differential gear 24.

The inverter 34 is used to drive the motor 32. The inverter 34 is connected to the battery 36 via power line 38 and includes six transistors T11-T16 as six switching elements and six diodes D11-D16 connected in parallel to each of the six transistors T11-T16. The transistors T11 to T16 are arranged in pairs such that they are source and sink side to positive and negative pole side lines of the power line 38, respectively. The connection points of the two transistors of each pair are connected to the coils of the corresponding phase (phase U, V, and W) of the motor 32, respectively. Therefore, when voltage is applied to the inverter 34, ratio of on-time of the paired transistors T11 to T16 is adjusted by the ECU 50 to form a rotating magnetic field in the three-phase coils and drive the motor 32 to rotate.

The battery 36 is configured as a lithium-ion secondary battery or nickel-metal hydride secondary battery and is connected to the inverter 34 via the power line 38. A smoothing capacitor 39 is attached to the power line 38.

The speaker 40 is located near driver's seat. The speaker 40 is configured as an audio output apparatus outputting audio in an aurally recognizable manner. The speaker 40 is controlled by the ECU 50.

The display 42 is located near the driver's seat. The display 42 is configured as a display apparatus visibly displaying various information. The display 42 is controlled by the ECU 50.

The ECU 50 is equipped with a microcomputer including a CPU, a ROM, a RAM, a flash memory, and input/output ports. The ECU 50 inputs rotational position θm of the rotor of the motor 32 from a rotational position sensor 32a, phase currents Iu, Iv of the U and V phases of the motor 32 from a current sensors 32u, 32v, voltage Vb of the battery 36 from a voltage sensor 36a, current Ib of the battery 36 from a current sensor 36b, and voltage VL of the power line 38 (the smoothing capacitor 39) from a voltage sensor 39a. The ECU 50 also inputs start signal from a start switch 60, shift position SP, which is operating position of a shift lever 61, from a shift position sensor 62, gas pedal opening degree Acc, which is the amount of depressing an accelerator pedal 63, from an accelerator pedal sensor 64, and brake pedal position BP, which is the amount of depressing a brake pedal 65, from a brake pedal sensor 66. The ECU 50 also inputs vehicle speed V from a vehicle speed sensor 67, switch signal from a mode changeover switch (mode selector) 68, and depression amount Da of a clutch pedal (pseudo clutch pedal) 70 from a clutch pedal sensor 71. The shift lever 61 is configured to simulate a shift apparatus provided by a vehicle equipped with a manual transmission. The shift lever 61 selects, as the shift position SP, one of several shift ranges corresponding to a gear shift of the manual transmission to be simulated, e.g., one of simulated first through sixth gear ranges and a neutral range. Each time the mode changeover switch 68 is turned on, the mode changeover switch 68 outputs a mode switching instruction to switch between a motor driving mode and a variable speed driving mode. The motor driving mode and variable speed driving mode are described below. The clutch pedal 70 is configured to simulate a clutch pedal on an engine vehicle to be simulated. The clutch pedal 70 is configured to be similar in placement and operational feeling to the clutch pedal of the vehicle equipped with the manual transmission. The ECU 50 outputs control signals to the motor 32, audio signals to the speaker 40, display signals to the display 42, etc.

In the battery electric vehicle 20 of the embodiment, the ECU 50 controls the motor 32 (the inverter 34) such that the battery electric vehicle 20 is driven in the motor driving mode, in which the required torque required for driving is output from the motor 32, and controls the motor 32 such that the battery electric vehicle 20 is driven in the variable speed driving mode with behavior of torque output from the motor 32 as the behavior of torque in the engine vehicle equipped with the engine and the manual transmission as a stepped transmission, based on the driver's operation of the shift lever 61.

In the motor driving mode, the ECU 50 sets torque command Tm* of the motor 32 to driving demand torque Td* required for driving (required for the drive shaft 26), regardless of the shift position SP or the depression amount Da of the clutch pedal 70, and controls the transistors T11 to T16 of the inverter 34 such that the motor 32 is driven by the torque command Tm*. The ECU 50 sets the driving demand torque Td* based on the gas pedal opening degree Acc and the vehicle speed V.

In the variable speed driving mode, the ECU 50 sets virtual engine rotation speed (simulated rotation speed) Ne as the engine rotation speed in the engine vehicle to be simulated, using rotation speed Np of the drive shaft 26 (rotation speed Nm of the motor 32), the gear ratio (transmission ratio) r corresponding to the shift position SP, and the slip ratio slip of the clutch pedal 70 based on the depression amount Da of the clutch pedal 70. The ECU 50 sets virtual engine output torque Teout to be output from the engine of the engine vehicle to be simulated based on the gas pedal opening degree Acc and the virtual engine rotation speed Ne. The ECU 50 calculates transmission input torque Tmtin by multiplying the virtual engine output torque Teout by torque transmission gain k, which is transmission rate of torque from the engine to the manual transmission based on the slip rate slip of the clutch pedal 70. The ECU 50 sets the torque transmission gain k to be smaller when the depression amount Da of the clutch pedal 70 is large than when the depression amount Da is small, and sets the torque transmission gain k to a value of 0 when the depression amount Da of the clutch pedal 70 is at the maximum depressing amount in which the torque transmission gain k between the engine and the manual transmission is at value 0. The ECU 50 calculates transmission output torque Tmtout by multiplying the transmission input torque Tmtin by the gear ratio (transmission gear ratio) r corresponding to the shift position SP, sets the torque command Tm* of the motor 32 to the transmission output torque Tmtout, and controls the transistors T11 to T16 of the inverter 34 such that the motor 32 is driven by the torque command Tm*. Through such control, the ECU 50 controls the motor 32 such that the battery electric vehicle 20 is driven based on the driver's operation of the shift lever 61 (shift operation), with the behavior of the torque output from the motor 32 as the behavior of torque in the engine vehicle with the engine and the manual transmission. This enables the battery electric vehicle 20 to run while simulating the engine vehicle equipped with the engine and the manual transmission, and enables the driver to feel as if the driver is driving the engine vehicle equipped with the engine and the manual transmission.

In the variable speed driving mode, the ECU 50 controls the speaker 40 such that sound (engine sound) linked to the virtual engine rotation speed Ne is output from pre-recorded engine sound for each engine rotation speed. The sound from the speaker 40 gives the driver an upshifting feeling as if the driver is driving the engine vehicle equipped with the engine and the manual transmission.

The following describes operation of the battery electric vehicle 20 of the embodiment having the configuration described above or more specifically the display on the display 42.

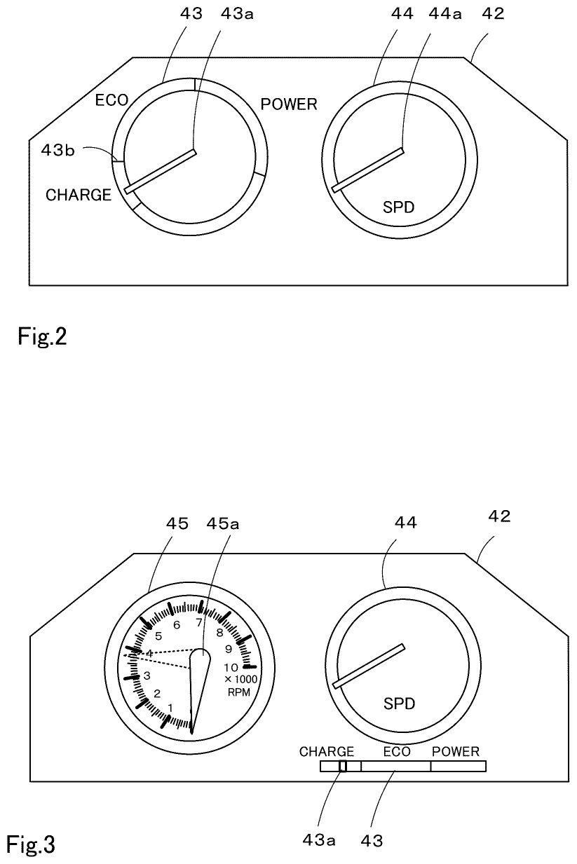

FIG. 2 illustrates one example of the display on the display 42 in the motor driving mode. In the motor driving mode, the ECU 50 controls the display 42 such that a power meter 43 and a speedometer 44 are displayed side by side and in the same size on the display 42. The power meter 43 displays the power output from the motor 32 caused by power drive of the motor 32 and the power output from the motor 32 caused by regenerative drive of the motor 32. In the power meter 43, when the motor 32 is power driven, as the power output from the motor 32 increases, a needle 43a of the power meter 43 changes to show from an origin position 43b through an “ECO” zone to a “POWER” zone. The “ECO” zone indicates a power range in which the power output from the motor 32 is suppressed, and in which the battery electric vehicle 20 is enabled to drive with less reduction in the state of charge of the battery 36. As the power output from the motor 32 decreases, the needle 43a of the power meter 43 changes toward the origin position 43b. In the power meter 43, when the motor 32 is driven regeneratively, as the power output from the motor 32 increases, the needle 43a of the power meter 43 changes from the origin position 43b to show the “CHRAGE” zone. The power meter 43 enables the driver to recognize the power being output from the motor 32, i.e., the power for driving, to encourage driving with a reduced state of charge of the battery 36, and to recognize that the battery 36 is charged with the regenerative power of the motor 32. The speedometer 44 displays the vehicle speed V detected by the vehicle speed sensor 67. The ECU 50 controls the display 42 such that as the vehicle speed V increases, the needle 44a of the speedometer 44 shows the scale corresponding to the vehicle speed V.

FIG. 3 illustrates one example of the display on the display 42 in a variable speed driving mode. In the variable speed driving mode, the ECU 50 controls the display 42 such that tachometer 45 and the speedometer 44 are displayed side by side in the same size on the display 42, and the power meter 43 is displayed as a bar below the speedometer 44. The tachometer 45 displays the virtual engine rotation speed Ne. As the virtual engine rotation speed Ne increases, angle of needle 45a of the tachometer 45 changes, as shown by a broken line. In the variable speed driving mode, a sound (engine sound) linked to the virtual engine rotation speed Ne is output from the speaker 40, as described above. The sound from the speaker 40 and the display on the tachometer 45 give the driver an upshifting feeling as if the driver is driving the engine vehicle including the engine and the manual transmission. Since the tachometer 45 is not displayed on the display 42 in the motor driving mode, the driver can recognize that the car is driven in the variable speed driving mode by the display of the tachometer 45 of the display 42, i.e., the display of the virtual engine rotation speed Ne. This enables the driver to recognize whether the vehicle is driven in the motor driving mode or in the variable speed driving mode.

As described above, in the battery electric vehicle 20 of the embodiment, when the mode changeover switch 68 selects the variable speed driving mode, the display 42 is controlled to display the virtual engine rotation speed Ne, and when the mode changeover switch 68 selects the motor driving mode, the display 42 is controlled not to display the virtual engine rotation speed Ne. This enables the driver to recognize whether the vehicle is driven in the motor driving mode or the variable speed driving mode.

In the embodiment described above, the ECU 50 displays the tachometer 45 and the speedometer 44 side by side and in the same size on the display 42, with the power meter 43 displayed as the bar below the speedometer 44. However, in the variable speed driving mode, the display 42 may show the tachometer 45, the speedometer 44, and the power meter 43 side by side and in the same size, or the tachometer 45, the speedometer 44, and the power meter 43 may be of different sizes, or the power meter 43 may not be displayed.

In the embodiment described above, the shift position SP is changed by the driver's operation of the shift lever 61. However, the present disclosure may be applied to battery electric vehicles that include two paddle switches located near a steering wheel and that change the shift position SP by upshifting or downshifting based on paddle signals from the paddle switches.

The following describes the correspondence relationship between the primary components of the embodiment and the primary components of the disclosure described in Summary. The motor 32 of the embodiment corresponds to the “motor”, the mode changeover switch 68 corresponds to the “mode selector”, the ECU 50 corresponds to the “controller”, and the display 42 corresponds to the “display apparatus”.

The correspondence relationship between the primary components of the embodiment and the primary components of the disclosure, regarding which the problem is described in Summary, should not be considered to limit the components of the disclosure, regarding which the problem is described in Summary, since the embodiment is only illustrative to specifically describes the aspects of the disclosure, regarding which the problem is described in Summary. In other words, the disclosure, regarding which the problem is described in Summary, should be interpreted on the basis of the description in the Summary, and the embodiment is only a specific example of the disclosure, regarding which the problem is described in Summary.

The aspect of the disclosure is described above with reference to the embodiment. The disclosure is, however, not limited to the above embodiment but various modifications and variations may be made to the embodiment without departing from the scope of the disclosure.

### INDUSTRIAL APPLICABILITY

The technique of the disclosure is preferably applicable to the manufacturing industries of the battery electric vehicle and so on.

What is claimed is:

1. A battery electric vehicle comprising:
a motor configured to output torque to a drive shaft connected to an axle;
a mode selector configured to select one driving mode from a plurality of driving modes, including a motor driving mode for driving while controlling the motor such that required torque required for driving is output to the drive shaft, and a variable speed driving mode for driving while controlling the motor based on driver's shift operation such that the torque output to the drive shaft becomes a torque simulating torque behavior in an engine vehicle equipped with an engine and a stepped transmission, by an operation of the driver;
a display apparatus configured to display information; and
a controller programmed to control the motor to run in the driving mode selected by the mode selector, and to control the display apparatus,
wherein the controller is programmed to control the display apparatus to display simulated rotation speed as rotation speed of the engine in the engine vehicle with simulated torque behavior in the variable speed driving mode and a speedometer displaying vehicle speed side by side and to display a power meter displaying power output from the motor below the speedometer when the variable speed driving mode is selected by the mode selector, and to control the display apparatus to display the speedometer and the power meter and not to display the simulated rotation speed when the motor driving mode is selected by the mode selector.

2. The battery electric vehicle according to claim 1, further comprising;
an audio output apparatus configured to output audio in an aurally recognizable manner,
wherein the controller is programmed to control the audio output apparatus such that a sound linked to the simulated rotation speed is output when the mode selector selects the variable speed driving mode.
